(19) United States
(12) Patent Application Publication
(10) Pub. No.: US 2013/0029550 A1
(43) Pub. Date: Jan. 31, 2013

(54) BREATHABLE COATED FABRIC

(71) Applicants: Manish K. Seth, Mission (CA); Gary Shokar, Vancouver (CA)

(72) Inventors: Manish K. Seth, Mission (CA); Gary Shokar, Vancouver (CA)

(73) Assignee: IBCO SRL, St. Michael (BB)

(21) Appl. No.: 13/637,323

(22) PCT Filed: Mar. 25, 2011
(86) PCT No.: PCT/CA2011/000317

§ 371 Date: Oct. 15, 2012

Related U.S. Application Data
(60) Provisional application No. 61/317,500, filed on Mar. 25, 2010.

(51) Int. Cl. B32B 27/12; B29C 47/06; D06N 3/00

(52) U.S. Cl. 442/76; 428/341; 156/244.11

(57) ABSTRACT

A water vapor-permeable, air-impermeable and water-impermeable sheet material comprises a film bonded to a fibrous substrate. The film comprises a reaction extrusion-processed blend comprising a first block copolymer which comprises a polyether block amide copolymer and a second block copolymer which comprises a copolyether ester. The fibrous substrate may be woven or non-woven, and may comprise polyethylene, polypropylene, polyethylene terephthalate, a polyamide, glass mat, felt, paper, or combinations thereof. The water vapor transmission rate of the extruded film is substantially higher than that of a film made from either one of the component block copolymers. The sheet material has uses which include housewrap, roofing underlayment, breathable apparel, desiccant packaging and others.

### FIELD OF THE INVENTION

The invention pertains to breathable coated fabrics which are permeable to water vapor and substantially impermeable to air and liquid water, and to methods of making the fabrics using reactive extrusion.

### BACKGROUND OF THE INVENTION

Moisture transport membranes are used in a variety of industrial applications where it is desirable to transmit moisture but avoid gross air or liquid transport.

In building construction, such membranes are used as housewraps to insulate houses and other buildings from air drafts and protect wooden and drywall substructure from liquid water. A high water vapor transmission rate is desired in order to allow interior humidity to escape and protect the interior drywall, wood and insulation from water saturation, causing decay and mold buildup. The breathable, i.e. water vapor-permeable, membrane must also serve as weather protection to protect against liquid water and air drafts. Materials commonly used for housewrap include flashspun high density polyethylene, microporous membranes of polypropylene or polyethylene, nonwoven polypropylene, and perforated polymer films. Commercially available polymeric housewraps include flashspun polyethylene sheet sold under the trade name Tyvek; polyolefin nonwoven sheet sold under the trade name Styrofoam Weathermate Plus; spunbonded polypropylene-microporous film laminate sold under the trade name Typar Weather Protection Membrane; woven polypropylene sheet with perforated coating sold under the trade name Pinkwrap; and coated nonwoven sheet material sold under the trade name WeatherSmart.

Moisture transport membranes for use as housewrap are selected based on their permeance rating, mechanical strength (tear strength, including wet tear strength), air penetration resistance and hydrostatic pressure resistance. Both woven and non-woven types of housewrap are commonly used. Non-woven housewraps typically have higher water vapor permeabilities than woven housewraps. The strength properties of woven housewraps are typically higher than for the non-woven counterparts.

For any housewrap application, permeance ratings are critical. Permeance ratings reflect the material's ability to transfer water vapor; the higher the perm number, the higher the water vapor transmission rate (WVTR). The permeance rating of a housewrap is a function of the WVTR, which rate is measured in grams per square meter per 24 hours in a conditioning chamber of 23 degrees C. (73.4 degrees F.) and 50% relative humidity, i.e. the water loss in grams per square meter per day. A measure of permeance is the US perm, defined as 1 grain per hour per square foot per inch of mercury, which is approximately 1/7^{th} of the WVTR value. For example, 6 mil monolithic polyolefin sheeting has a perm rating of approximately 0.06 perms, meaning that only 0.42 grams per square meter per day will be transferred from a high moisture or high pressure zone to a low moisture or pressure area. This is a very low perm number and the sheeting can be classified to some degree as a moisture barrier. Perm ratings of commonly available housewraps include 6.7 perms for Weathermate, 58.0 perms for Tyvek and 59.0 perms for R-Wrap (trade mark). Products with higher perm ratings speed the escape of trapped moisture and are desirable for this function. The higher permeance products currently available in North America are based on microporous technology. Such products can offer higher permeance but are more susceptible to liquid water infiltration.

Commercially available housewraps having monolithic coatings have lower permeance ratings than the higher microporous alternatives. Such existing products have water vapor transfer rates in the range of 42 to 80 grams per square meter per 24 hours, depending on type of breathable resin chemistry, film weight and type of base substrate. Monolithic films have the inherent advantages of good oxygen barrier properties, which improves energy efficiency, and surfactant resistance, which reduces susceptibility to liquid water infiltration.

In addition to high water vapor permeance, a housewrap should also have high water resistance, high tensile and tear strength, minimal air infiltration, good UV resistance, surfactant resistance, and nail sealability.

Moisture transport membranes are also use in moisture transport humidifiers. Such humidifiers, also called energy recovery ventilators (ERV), are used to transport moisture from a humid airstream to a dry airstream. They may be used to capture or release the latent heat in exiting air in closed-air HVAC systems to improve overall HVAC efficiency. In fuel cell systems, humidifiers are used to keep fuel cell engine components humidified by recovering moisture from the exiting airstream into the inlet airstream. In both cases, the humidifier must transport water vapor effectively while blocking crossover of air. Crossover of air would result in a bypass of the humidifier and subsequent reduced efficiency. A suitable water transport membrane can be made using perfluoro-sulfonic acid, e.g. Nafion (trademark), but the cost is prohibitive for many applications. Commercial ERV humidifiers typically use membranes made from microporous films. Such films often require a coating to reduce the air crossover. For humidifiers, it is desirable to have high moisture transport rate and the ability to withstand broad temperature range fluctuations without failure or air or gas crossover. Membranes in ERV humidifiers used in HVAC are subject to building codes and must meet specific flame ratings.

In addition to housewrap and humidifier applications, water transport membranes are also used in desiccant packaging where desiccants such as silica must be encapsulated in a high moisture transportable film and must not allow such desiccants to escape the package. One application for desiccant packages is in medication tubes to maintain freshness and capture any moisture that may enter.

Breathable apparel is required to prevent any air crossover while allowing moisture through perspiration to escape. Commercial products that exhibit this characteristic include Gortex (trademark), Sympatex (trademark), and Diaplex (trademark). Such materials typically have a permeance exceeding 31,000 grams per square meter per 24 hours (using test method JIS L1099, typically used for apparel)

There are disadvantages associated with the existing breathable membranes. Some examples include the following. Tyvek flash spun nonwoven is costly, has tear propagation once a tear is introduced, and loss of hydrophobicity when exposed to surfactant. Nafion is costly, limiting it to specialty applications, and it requires reinforcement for strength. Microporous films have lower perm ratings, require a coating (e.g. polyurethane) to fully stop air permeability, and are hydrophilic when exposed to surfactant. Perforated films have low permeance ratings, and high air flow-through. Deterioration of the perforated film results in perforation distortions and may allow water to penetrate.

It is known that polyamides (nylon) have significant moisture permeability with nylon 6 and nylon 12 having high moisture permeability. However, nylon films are not suitable to be processed using an extrusion coating process, especially for thin coating weights. In order to process polyamide resins using extrusion coating, a tie layer resin must be incorporated, such as EMA or EVA, which reduces the water vapor transmission rates when compared to the films made with pure nylon resin.

Polyester-based resins are also known to provide water vapor transfer characteristics; however, conventional polyester-based resins offer limited permeance and do not sufficiently bond to polyolefin scrims or nonwovens.

Nylon cannot be sufficiently bonded to polyolefin scrims or nonwovens without use of a tie layer. Conventional tie resins reduce the water transport rate significantly. Polyamides and polyesters are dissimilar polymers and are not able to blend with one another to yield a uniform monolithic coating.

There remains a need for an effective moisture transfer membrane and fabric which ameliorate at least some of the disadvantages of existing products.

### SUMMARY OF THE INVENTION

The present inventors have discovered that a composite fabric can be made using a polymeric film formed by reactive extrusion of at least two block copolymers, in which the extruded film has a substantially higher water vapor transmission rate than either one of the component block copolymers. The extruded film is bonded to a fibrous substrate to form the composite fabric. The fabric has a high WVTR and is substantially impervious to air and liquid water, making it suitable for use as housewrap and for many other applications.

According to one aspect of the invention, there is provided a water vapor-permeable sheet material comprising: (a) a film comprising a reaction extrusion-processed blend comprising a first block copolymer which comprises a polyether block amide copolymer and a second block copolymer which comprises a copolyether ester; and (b) a fibrous substrate bonded to the film.

According to a second aspect of the invention, there is provided a method of making a water vapor-permeable, air-impermeable, liquid water-impermeable sheet material, comprising the steps of (a) processing by a reactive extrusion process a blend comprising a first block copolymer which comprises a polyether block amide copolymer and a second block copolymer which comprises a copolyether ester, to produce an extruded film; and (b) bonding the extruded film to a fibrous substrate to form the sheet material.

Further aspects of the invention and features of specific embodiments of the invention are described below.

### DETAILED DESCRIPTION

In the present specification, unless otherwise specified, all stated measurements of water vapor transmission rate (WVTR) are done according to ASTM E-96 Procedure B; all stated measurements of air resistance are done according to TAPPI 460 (Gurley method); all stated measurements of hydrostatic water head are done according to AATCC test method 127 or CCMC 0702; and all stated measurements of tensile strength are done according to ASTM D751/ASTM D 5034 cut strip method. All stated percentages of components refer to percentage by weight.

The sheet material of the invention is a composite that comprises a film bonded to a fibrous substrate. The material is highly permeable to water vapor but is substantially impermeable to air and liquid water.

The film is made by reactive extrusion of polymers. It comprises a reaction extrusion-processed blend comprising a first block copolymer which comprises a polyether block amide copolymer and a second block copolymer which comprises a copolyether ester.

In the first block copolymer, the polyamide block may comprise polyamide 6, 11 or 12. The polyether block comprises a polyalkylene glycol, for example polyethylene glycol, polypropylene glycol or polytetramethylene glycol. The polyether block amide copolymer may be the product of polycondensation of a carboxylic acid polyamide with an alcohol termination polyether. The first block copolymer may be a polyether block amide copolymer sold under the trade name Pebax by Arkema Inc. of Philadelphia Pa.

The second block copolymer comprises polyether blocks and polyester blocks. The polyether blocks comprise a poly (alkylene oxide), for example polyethylene glycol, polypropylene glycol or polytetramethylene glycol. The polyester blocks of the second block copolymer comprise a poly (alkylene terephthalate), for example polybutylene terephthalate or polyethylene terephthalate. The second block copolymer may be a product sold under the trade name Arnitel by DSM Engineering Plastics B.V. of Sittard, Netherlands.

The blend may optionally include additives such as a compatibilizer, a colorant and a UV-inhibitor. A compatibilizer improves the processability of immiscible polymers and stabilizes the melt curtain. The compatibilizer may, for example, comprise a polymer functionalized by maleic anhydride grafting, ethylene methyl acrylate copolymer, or ethylene vinyl acetate (EVA). Breathable products made without compatibilizer require longer residence time, which reduces the productivity and affects the melt curtain stability at higher throughputs.

The substrate layer can be a woven or non-woven fabric or a combination of both, depending on the intended application. The substrates can be in the form of a film, natural and synthetic textiles, woven scrim, non-wovens and glass mat. The fibrous substrates can be used alone or in combination with one another using a tie layer to laminate the substrates. Calcium carbonate stretched polyolefin film can also be laminated to the fibrous substrate.

The woven fabric may comprise polyethylene, polypropylene, polyester, polyamide, glass mat, felt, paper, or combinations thereof The woven fabric has machine direction and cross direction tapes, typically manufactured by a sheet extrusion process followed by slitting, stretching, orientating and annealing of tapes.

In other embodiments, the substrate can be a non-woven fabric comprising, for example, randomly laid spun-bonded fibers and made with polyolefins such as polyethylene, polypropylene, polyester, wood fiber-based polyolefins sold under the trade name Sontara by DuPont, or combinations thereof Suitable spunbonded non-wovens are commercially available under the trade name Typar sold by BBA Fiberweb. The non-woven may alternatively be a flashspun non-woven material such as flashspun high density polyethylene, sold by DuPont under the trade name Tyvek.

The film is produced by reactive extrusion. Reactive extrusion (REX) is a process well known in the art of reacting polymers, as described, for example, in Richards et al, U.S. Pat. No. 5,770,652. The reactive extrusion process allows the control of the rate of reaction by changing the process parameters, including the extruder temperatures, melt temperature, residence time of polymers in the extruder, nip pressure, polymer blend ratios and coating weight thickness. In the present invention, by controlling the rate of reaction between polymers and varying the polymer blend ratios, the perm ratings of the finished product can be controlled within a range from 35 to 1200 grams per square meter per day. The chemical reaction between the specified polymer blends produces a unique crosslinked structure by rearranging the polymer chains/network, to produce a film that is substantially more vapor permeable than either of the individual polymers used in the blend.

The polymer blend reactants are fed into the extruder feed throat where the material is heated to initiate the reaction or increase the rate of reaction.

The material is then conveyed through sequential barrel segments where the degree of mixing and specific energy input bring the reaction to the desired degree of completion within the limits of residence time in the extruder. The residence time may be in the range of 5-220 seconds, alternatively 5-100 seconds. The molten polymer is then forced from the extruder through a slit or coat hanger design die at 430-600 degrees F. (221-315 degrees C.), alternatively 450-560 degrees F. (232-293 degrees C.), and then directly applied onto the fibrous substrate. The coated substrate is then nipped between a chill roll and rubber roll to achieve the required lamination bond strength. The nip pressure may be in the range of 8-150 psi (55-1,034 kPa).

In order to achieve the superior lamination bond strength, sometimes corona treatment, flame treatment or liquid primer on fibrous substrate may be used before coating the substrate. The air gap used in the reactive extrusion process may be in the range of 3.5-10 inches (8.9-25.4 cm).

The WVTR of the breathable coated fabric product was measured and compared with fabrics made using the individual block copolymer components rather than the blend. As an example, a breathable coated product made according to the invention had a WVTR rating of 789 grams per square meter per day. The WVTR of the polyether block amide copolymer coated breathable product alone had a WVTR rating of only 56 grams per square meter per day. The WVTR of the copolyether ester coated breathable product alone had a WVTR rate of only 175 grams per square meter per day. Expressed in terms of perms, the rating of the polyether block amide copolymer is up to about 10 perms, and of the copolyether ester is up to about 30 perms, whereas the rating of the blended product according to the invention is about 100 perms.

The weight of the extruded film may be in the range of 10-150 grams per square meter, the weight of the substrate in the range of 15-350 grams per square meter, and the weight of the product sheet material in the range of 25-500 grams per square meter, the weights being selected based on the intended uses of the finished product. The sheet material has a WVTR in the range of 35-1,200 grams per square meter per day, an air resistance of at least 10,000 sec/100 cc, a hydrostatic water head of at least 55 cm per AATCC 127 (or 25.4 mm of water per CCMC 07102), and a tensile strength in the range of 5-130 pounds per inch (34-896 kPa).

The composite product acts as a barrier to airflow, liquids, bacteria and odors, yet is also highly permeable to water vapor. Uses of the product include building applications such as housewrap, roofing underlayment or flashing, breathable apparel, desiccant packaging, surgical barriers, medical wraps, a mattress covers, pillow covers, diapers, humidifier membranes, filters including HVAC filters, and gas containment structures.

### EXAMPLE 1

A blend of 76% Arnitel 3104, 20% Pebax MV3000, 2% Fusabond N416 (a compatibilizer sold by DuPont) and 2% UV stabilizer was processed using reactive extrusion at temperatures in the range of 480-535° F. (249-279 degrees C.). Arnitel 3104 is a copolyetherester having hard segments derived from at least one low molecular weight glycol and at least two dicarboxylic acids, esters there of chosen from the group comprising 2,6-napthalenedicarboxylic acid, 4,4-diphenyldicarboxylic acid and terephthalic acid and containing soft segments derived from the group comprising poly (alkylene oxides). Pebax MV3000 is a polyether amide block copolymer.

The extruder screw design utilized had two mixing zones that are 240 mm long to improve the mixing and miscibility of the polymer blend and prevent the formation of gel in-homogeneities. The residence times were in the range of 0.8-2.5 minutes. The throughputs were in the range of 10-900 kg/hr at screw speeds of 20-250 rpm.

The monolithic coating was extrusion laminated at a weight of 24 grams per square meter directly onto a 2.2 oz per square yard polyester non-woven substrate. The WVTR of the breathable coated fabric product was 749 grams per square meter per day. The air resistance of the product was greater than 10,000 sec/100 cc.

### EXAMPLE 2

A blend of 60% Arnitel 3108, 10% Pebax MV3000, 28% Westlake EMAC SP2207 (a compatibilizer sold by Westlake Chemical Corporation of Houston Tex.) and 2% UV stabilizer was extrusion laminated at a weight of 24 grams per square meter directly onto a 2.2 oz per square yard polyester non-woven substrate. The blend was processed using reactive extrusion process at the temperature range of 460 to 530° F. (238-277 degrees C.). The WVTR of the breathable coated fabric product was 560 grams per square meter per day. The air resistance of the product was greater than 10,000 sec/100 cc.

As will be apparent to those skilled in the art in the light of the foregoing disclosure, many alterations and modifications are possible in the practice of this invention without departing from the scope thereof. Accordingly, the scope of the invention is to be construed in accordance with the following claims.

1. A water vapor-permeable sheet material comprising:
(a) a film comprising a reaction extrusion-processed blend comprising a first block copolymer which comprises a polyether block amide copolymer and a second block copolymer which comprises a copolyether ester; and
(b) a fibrous substrate bonded to the film.

2. A material according to claim 1, wherein the first block copolymer comprises polyamide blocks and polyether blocks.

3. A material according to claim 2, wherein the polyamide block comprises polyamide 6, 11 or 12.

4. A material according to claim 2, wherein the polyether block comprises a polyalkylene glycol.

5. A material according to claim 2, wherein the polyether block comprises polyethylene glycol, polypropylene glycol or polytetramethylene glycol.

6. A material according to claim 1, wherein the first block copolymer is the product of polycondensation of a carboxylic acid polyamide with an alcohol termination polyether.

7. A material according to claim 1, wherein the first block copolymer is Pebax.

8. A material according to claim 1, wherein the second block copolymer comprises polyether blocks and polyester blocks.

9. A material according to claim 8, wherein the polyether blocks of the second block copolymer comprise a poly (alkylene oxide).

10. A material according to claim 9, wherein the poly (alkylene oxide) comprises polyethylene glycol, polypropylene glycol or polytetramethylene glycol.

11. A material according to claim 8, wherein the polyester blocks comprise a poly (alkylene terephthalate).

12. A material according to claim 11, wherein the poly (alkylene terephthalate) comprises polybutylene terephthalate or polyethylene terephthalate.

13. A material according to claim 1, wherein the second block copolymer comprises Arnitel.

14. A material according to claim 1, wherein the blend further comprises a compatibilizer.

15. A material according to claim 14, wherein the compatibilizer comprises a polymer functionalized by maleic anhydride grafting.

16. A material according to claim 14, wherein the compatibilizer comprises ethylene methyl acrylate copolymer or ethylene vinyl acetate.

17. A material according to claim 1, wherein the blend further comprises a colorant or a UV-inhibitor, or both.

18. A material according to claim 1, wherein the substrate is woven.

19. A material according to claim 18, wherein the substrate comprises polyethylene, polypropylene, polyethylene terephthalate, a polyamide, glass mat, felt, paper, or combinations thereof.

20. A material according claim 1, wherein the substrate is non-woven.

21. A material according to claim 1, wherein the sheet material is substantially air-impermeable and liquid water-impermeable.

22. A material according to claim 1, wherein the weight of the film is in the range of 10-150 grams per square meter.

23. A material according to claim 1, wherein the weight of the substrate is in the range of 15-350 grams per square meter.

24. A material according to claim 1, wherein the weight of the sheet material is in the range of 25-500 grams per square meter.

25. A material according to claim 1, wherein the sheet material has a moisture vapor transmission rate in the range of 35-1,200 grams per square meter per day.

26. A material according to claim 1, wherein the sheet material has an air resistance of at least 10,000 sec/100 cc.

27. A material according to claim 1, wherein the sheet material has a hydrostatic water head of at least 55 cm per AATCC 127.

28. A material according to claim 1, wherein the sheet material has a tensile strength in the range of 5-130 pounds per inch (34-896 kPa).

29. A material according to claim 1, wherein the film is monolithic.

30. A material according to claim 1, wherein the substrate is bonded to the film by reactive extrusion of the film directly onto the substrate.

31. A material according to claim 1, wherein the sheet material is for use as housewrap, roofing underlayment or flashing.

32. A material according to claim 1, wherein the sheet material is for use as breathable apparel, desiccant packaging, a surgical barrier, a medical wrap, a mattress cover, a pillow cover, a diaper, a humidifier membrane, a filter, or a gas containment structure.

33. A method of making a water vapor-permeable sheet material, comprising the steps of:
(a) processing by a reactive extrusion process a blend comprising a first block copolymer which comprises a polyether block amide copolymer and a second block copolymer which comprises a copolyether ester, to produce an extruded film; and
(b) bonding the extruded film to a fibrous substrate to form the sheet material.

34. A method according to claim 33, wherein the reactive extrusion process is carried out at a temperature in the range of 430-600 degrees F.(238-277 degrees C.).

35. A method according to claim 33, wherein the reactive extrusion process is carried out for a residence time in the range of 5-220 seconds.

36. A method according to claim 33, wherein the reactive extrusion process is carried out for a residence time in the range of 5-100 seconds.

37. A method according to claim 33, wherein the step of bonding comprises extruding the film onto the substrate and passing the material through a nip.

38. A method according to claim 37, wherein the nip exerts a pressure in the range of 8-150 psi (55-1,034 kPa).

39. A method according to claim 33, wherein an air gap used in the reactive extrusion process is in the range of 3.5-10 inches (8.9-25.4 cm).

40. A method according to claim 33, wherein the first block copolymer comprises polyamide blocks and polyether blocks.

41. A method according to claim 40, wherein the polyamide block comprises polyamide 6, 11 or 12.

42. A method according to claim 40, wherein the polyether block comprises a polyalkylene glycol.

43. A material according claim 40, wherein the polyether block comprises polyethylene glycol, polypropylene glycol or polytetramethylene glycol.

44. A material according to claim 33, wherein the first block copolymer is the product of polycondensation of a carboxylic acid polyamide with an alcohol termination polyether.

45. A method according to claim 33, wherein the first block copolymer is Pebax.

46. A method according to claim 33, wherein the second block copolymer comprises polyether blocks and polyester blocks.

47. A method according to claim 46, wherein the polyether blocks of the second block copolymer comprise a poly (alkylene oxide).

48. A method according to claim 47, wherein the poly (alkylene oxide) comprises polyethylene glycol, polypropylene glycol or polytetramethylene glycol.

49. A method according to claim 46, wherein the polyester blocks comprise a poly (alkylene terephthalate).

50. A method according to claim 49, wherein the poly (alkylene terephthalate) comprises polybutylene terephthalate or polyethylene terephthalate.

51. A method according to claim 33, wherein the second block copolymer comprises Arnitel.

52. A method according to claim 33, wherein the blend further comprises a compatibilizer.

53. A method according to claim 52, wherein the compatibilizer comprises a polymer functionalized by maleic anhydride grafting.

54. A method according to claim 52, wherein the compatibilizer comprises ethylene methyl acrylate copolymer.

55. A method according to claim 33, wherein the blend further comprises a colorant or a UV-inhibitor, or both.

56. A method according to claim 33, wherein the substrate is woven.

57. A method according to claim 56, wherein the substrate comprises polyethylene, polypropylene, polyethylene terephthalate, a polyamide, glass mat, felt, paper, or combinations thereof.

58. A method according to claim 33, wherein the substrate is non-woven.

59. A method according to claim 33, wherein the sheet material is substantially air-impervious and liquid water-impervious.
